(19) United States
(12) Patent Application Publication
(10) Pub. No.: US 2009/0258249 A1
(43) Pub. Date: Oct. 15, 2009

(54) Alloy for Liquid-Phase Diffusion Bonding

(75) Inventors: Hiroaki Sakamoto, Chiba (JP); Yuichi Sato, Chiba (JP); Yasushi Hasegawa, Chiba (JP); Youji Mizuhara, Chiba (JP)

Correspondence Address: BIRCH STEWART KOLASCH & BIRCH, PO BOX 747, FALLS CHURCH, VA, 22040-0747, US

(73) Assignee: NIPPON STEEL CORPORATION, Chiyoda-ku, Tokyo (JP)

(21) Appl. No.: 12/085,432

(22) PCT Filed: Jan. 26, 2007
(86) PCT No.: PCT/JP2007/051740

§ 371 Date: May 23, 2008

(30) Foreign Application Priority Data
Jan. 31, 2006 (JP) 2006-022705
Oct. 18, 2006 (JP) 2006-284080
Dec. 25, 2006 (JP) 2006-348064

(51) Int. Cl. B32B 15/01; B23K 35/30; B23K 35/24

(52) U.S. Cl. 428/678; 148/23

(57) ABSTRACT

An alloy having a low melting point for liquid-phase diffusion bonding capable of bonding both Ni-based heat resistance alloy material and Fe-based steel material. The alloy comprises in atom percent (%): 22<Ni≦60, B: 12-18, C: 0.01-4, and the balance being Fe and residual impurities; or comprises in atom percent (%): 22<Ni≦60, B: 7-18, 4≦C≦11, and the balance being Fe and residual impurities.

This application claims priority to Japanese Application No. 2006-027705 filed in Japan on Jan. 31, 2006, Japanese Application No. 2006-284080 filed in Japan on Oct. 18, 2006 and Japanese Application No. 2006-348064 filed in Japan on Dec. 25, 2006 and which are herein incorporated by reference in its entirety.

### FIELD OF TECHNOLOGY

The present invention relates to alloys used for liquid-phase diffusion bonding for bonding metal materials using liquid-phase diffusion, in particular alloys suitable for bonding by liquid-phase diffusion a variety of parts or structures constituted with carbon steel, stainless steel, heat-resistant steel, etc.

### BACKGROUND OF THE INVENTION

The liquid phase diffusion bonding process bonds base materials (i.e., the materials to be bonded) by inserting therebetween a metal (hereinafter referred to as an “insert metal”) in the form of a foil, a powder or a plated layer having a melting point lower than that of the base materials, and heating the portion up to a temperature immediately above the liquidus line of the insert metal to cause melting and isothermal solidification of the insert metal.

A variety of insert metals for liquid phase diffusion bonding have been proposed as shown, for example, in the references of (1) JP-A60-67647, (2) JP-A02-151377, (3) JP-A09-323175, (4) JP-A07-276066, (5) JP-A2004-1064, (6) JP-A2004-1065 or (7) JP-A2004-114157. JP-A60-67647 discloses filler metal (insert metal) available in the form of a foil, which is homogeneous, ductile, and useful for bonding austenitic stainless steels. The filler metal composition comprises, in atom percent (%), Cr:16-28, Ni:6-22, B:5-22, Si:0-12, C: 0-17, Mo:0-2, and the balance being Fe and residual impurities.

JP-A02-151377 discloses a foil of a nickel-based bonding alloy with added vanadium that is capable of liquid-phase diffusion bonding in oxidizing atmospheres. The composition of the alloy foil disclosed in JP-A02-151377 comprises, in atom percent (%), 0.5≦B≦10, Si: 15.0-30.0, V: 0.1-20.0, and the balance being Ni and residual impurities; and further additionally comprises Cr: 0.1-20.0, Fe: 0.1-20.0 and Mo:0.1-20.0, or W:0.1-10.0 and Co: 0.1-10.0. JP-A02-151377 describes that: (1) Cr, Fe and Mo are added to lower the difference between mechanical properties of the insert metal and the metal to be bonded, and the added amount is determined according to the content of alloy components of the metal to be bonded; and (2) W and Co are added to form a precipitate of an intermetallic compound or a carbide which increases the strength of the bonding.

JP-A09-323175 discloses a foil of the liquid-phase diffusion bonding alloy capable of bonding in oxidizing atmospheres, at a lower temperature and in a shorter time to Fe-based materials such as a steel pipe of carbon steel, a steel reinforcing bar, steel thick plate, etc. The composition of the foil of the liquid-phase diffusion bonding alloy disclosed in JP-A09-323175 comprises, in atom percent (%), P: 1.0-20.0, Si: 1.0-10.0, V: 0.1-20.0, B:1.0-20.0 and the balance being Fe and residual impurities; and further additionally comprises Cr: 0.1-20.0, Ni: 0.1-15.0 and/or Co: 0.1-15.0, or W: 0.1-10.0, Nb: 0.1-10.0 and/or Ti: 0.1-10.0. The reference also describes that Ni is capable of increasing corrosion resistance and oxidation resistance, and W, Nb and Ti are capable of increasing the strength of the bonded portion.

JP-A07-276066 discloses a foil of an alloy for bonding a heat-resistant steel and a heat-resistant alloy steel using liquid-phase diffusion bonding in an oxidizing atmosphere to make a bonded joint with high reliability excellent in heat-resistant properties. The composition of the alloy foil disclosed in JP-A07-276066 comprises, in mass percent (%), Si: 6.0-15.0, Mn: 0.1-2.0, Cr: 0.5-30, Mo:0.1-5.0, V: 0.5-10.0, Nb: 0.02-1.0, W: 0.10-5.0, N: 0.05-2.0, P: 0.50-20.0, and the balance being Ni and residual impurities. In this liquid-phase diffusion bonding alloy foil, Cr and Mo are added to improve the corrosion resistance of the joint and W is added to increase the high-temperature creep strength by solid solution strengthening and particularly to lower the difference between the mechanical properties of the heat-resistant steel having high creep strength and the liquid-phase diffusion bonding alloy foil.

JP-A2004-1064 discloses a low melting point liquid-phase diffusion bonding alloy for enabling lower temperature bonding aiming at improved bonding strength. The iron-based low melting point liquid-phase diffusion bonding alloy described in the reference has a composition comprising, in atom percent (%), B: 6-14, Si: 2-3.5, C: 0.2-4, P: 1-20, and the balance being Fe and residual impurities. This bonding alloy has a melting point of 1,100° C. or less and may include additional components of Ni: 0.1-20, Cr: 0.1-20 and/or V: 0.1-10 in atom percent (%).

JP-A2004-1065 discloses a liquid-phase diffusion bonding alloy for enabling lower temperature bonding and improving the quality of the material of the bonding layer and the bond strength. The iron-based low melting point liquid-phase diffusion bonding alloy described in the reference has a composition comprising, in atom percent (%), B: 6-14, Si<2, C: 2-6, P: 1-20, and the balance being Fe and residual impurities. This bonding alloy has a melting point of 1,100° C. or less and may include additional components of Ni: 0.1-20, Cr: 0.1-20 and/or V: 0.1-10 in atom percent (%).

JP-A2004-114157 discloses a liquid-phase diffusion bonding alloy capable of improving the quality of the material of the bonding layer formed after the bonding. The iron-based bonding alloy described in the reference has a composition comprising, in atom percent (%), B: 6-14, P: 1-20, and the balance being Fe and residual impurities. This bonding alloy may include additional components of Si<2, C<2, Ni: 0.1-20, Cr: 0.1-20 and/or V: 0.1-10 in atom percent (%).

In the above references, (5) JP-A2004-1064, (6) JP-A2004-1065 or (7) JP-A2004-114157, it is described that Ni is useful for lowering the melting point as long as the concentration is 20 atom percent (%) or less, and is not useful when the concentration becomes more than 20 (%).

As indicated in the above references, the conventional liquid-phase diffusion bonding alloy contains Ni, Cr, Fe, and/or Mo. This is because it is thought that it is important to make the composition of the insert metal similar to that of the base material (metal to be bonded) so that the mechanical property difference between the insert metal and the base material can be lowered. Also, W, Co, Mn and/or Ti can be added to the conventional insert metal to improve the strength of the bonding. Further P is added to the iron-based bonding foil to lower the melting point to 1,100° C. or below.

In the above-mentioned liquid-phase diffusion bonding alloy such as Ni-based bonding foil or Fe-based bonding foil, however, a bonding foil to be used has to be changed depending on the kind of alloy of the base material to be bonded since the bonding strength of bonded material is to be secured by using a bonding foil containing components which are similar to that of the base material to be bonded. For example, a Ni-based alloy foil is used for bonding Ni-based heat resistant alloy material and a Fe-based alloy foil is normally recommended for bonding a steel material of a Fe-based alloy, although a Ni-based bonding foil can be used. Also, P may be added to the conventional liquid-phase diffusion bonding alloy so as to lower the melting point. However, the addition of P does not always bring the preferable result with steel materials.

### SUMMARY OF THE INVENTION

An object of the present invention is to provide a liquid-phase diffusion bonding alloy which is capable of bonding both the heat resistant alloy materials of a Ni-based alloy and the steel materials of a Fe-based alloy, providing sufficient bonding strength and yet the liquid-phase diffusion bonding alloy has a lower melting point.

In a first embodiment of the invention is a liquid-phase diffusion bonding alloy comprising, in atom percent (%), 22<Ni≦60, B: 12-18, C: 0.01-4, and the balance being Fe and residual impurities.

In a second embodiment of the invention is a liquid-phase diffusion bonding alloy comprising, in atom percent (%), 22<Ni≦60, B: 7-18, 4<C≦11, and the balance being Fe and residual impurities

The liquid-phase diffusion bonding alloy can further comprise 0.01≦Si<1 in atom percent (%) so that the melting point of the bonding alloy can be lowered.

The liquid-phase diffusion bonding alloys of the first and second embodiments of the inventions preferably have a melting point ranging from 1030° C. to 1100° C. and the ratio of (strength of bonded portion)/(strength of base material) is preferably 1.00 or more.

The liquid-phase diffusion bonding alloys of the first and second embodiments of the invention can comprise W and/or Mo of which total content is 0.1-5%. This makes it possible to lower the melting point of the bonding alloy and to perform bonding in oxidizing atmospheres in addition to bonding in inert atmospheres.

The liquid-phase diffusion bonding alloys can further comprise Cr in a concentration of 0.1-20 atom percent (%). This enables improved corrosion resistance and oxidation resistance without increasing the melting point.

It is possible to add V in a concentration of 0.1-10 atom percent (%) to enable the bonding in an oxidizing atmosphere by melting an oxidized film formed on the base material.

In the first and second embodiments of the invention, the concentration of the Ni, which is a primary element of the liquid-phase diffusion bonding alloy is optimized, which leads to the relative optimization of the concentration of the Fe, which is another primary element. Consequently, liquid-phase diffusion bonding can be performed on both base materials of Fe-based alloy and Ni-based alloy. Also, the concentration of the B and C in the liquid-phase diffusion bonding alloy is optimized so that the melting point is lowered. This makes it possible to lower the required temperature of heating for bonding, which leads to the prevention of degradation of the structure (by such mechanisms as coarsening of crystal grains of the base material) and to realize an increase of bonding strength.

### DETAILED DESCRIPTION OF THE INVENTION

Preferred embodiments of the present invention are described below. In the following description, the percent (%) values represent atom percent in the alloy composition.

The present invention is made based on the finding by inventors of the present invention that an insert metal of liquid-phase diffusion bonding alloy can be applied to bonding base materials of both Fe-based alloy and Ni-based alloy by using a composition of the insert metal in a specific range. The finding was obtained after repeatedly experimenting with liquid-phase diffusion bonding using Fe-based alloy materials such as carbon steel or stainless steel and Ni-based alloy materials such as heat resistance alloy as base materials to be bonded.

The main feature of the present invention is that the concentration of B, Si and C are set in a limited narrow range while the concentration of Fe and Ni are set in a specific range in order to lower the melting point of liquid-phase diffusion bonding alloy. The inventors of the present invention examined 20 different elements to be added to the composition of the bonding alloy to lower the melting point further and found W and Mo can greatly lower the solidus line temperature (melting point) and the liquidus line temperature of the alloy. In particular W is capable of lowering the liquidus line temperature so significantly that the difference between the liquidus line temperature and the solidus line temperature can be reduced, which enables further lowering of the heating temperature for bonding. The inventors, also found that the addition of W and/or Mo makes it possible to perform bonding not only in inert atmospheres but also in oxidizing atmospheres.

A liquid-phase diffusion bonding alloy (hereinafter referred to as simply “bonding alloy”) of the first embodiment of the present invention (this may be called simply “first invention”) is explained below. The bonding alloy of the first embodiment comprises, in atom percent (%), 22<Ni≦60, B: 12-18 and C: 0.01-4, and the balance being Fe and residual impurities. With respect to each component to be added to the bonding alloy of this embodiment, the reasons for using each component in its respective concentration are explained below.

With respect to Ni, Ni is used in a concentration range of 22<Ni≦60%. Ni is one of the primary elements in the bonding alloy of the invention as well as Fe. In the case where the concentration of Ni is 22% or less, however, lowering of the melting point is not sufficient and also the bonding strength is not sufficient when a Ni-based base material is being bonded to. In the case where the concentration of Ni is more than 60%, the concentration of Fe has to be reduced, relatively. This causes a reduction in the bonding strength when the Fe-based base material is being bonded to. In view of this, the Ni concentration ranges preferably from more than 22% to 60% or less, more preferably from 30 to 50%. By keeping Ni in the range above, the bonding strength can be improved in the case of bonding to a Fe-based base material and in the case of bonding to a Ni-based base material.

With respect to B, B is used in a concentration range of 12-18%. B is capable of performing an isothermal solidification by diffusing from the bonding alloy into the base material to be bonded during liquid-phase diffusion bonding. Therefore, B is a highly preferred element in the bonding alloy of this invention. This narrow range in the concentration of B provides an excellent effect when used in combination with a primary element of the bonding alloy of the invention such as Fe and Ni. Specifically, when the concentration of B is less than 12%, sufficient lowering of melting point can not be made even if the concentration of Fe and Ni remain within the range described above. This bonding alloy is preferred not to be applied to bonding base materials of both Fe-based alloy and Ni-based alloy except for bonding some types of steel. That is, an object of the inventions is that the bonding alloy (insert metal) can be applied to bonding of both Ni-based alloy base materials and Fe-based alloy base materials. When the concentration of B exceeds 18%, the melting point is raised and it takes time for B to diffuse during isothermal solidification. This may result in the need for longer heating for bonding and deterioration of strength of base material. In view of this, it is better to keep the concentration of B in the range of 12-18%, preferably the range is 13-16%.

With respect to C, C is used in a concentration range of 0.01-4%. In the case where an amorphous foil of the bonding alloy of the invention is formed using a single roll casting process, C is capable of improving the wettability between the molten metal and the cooling roll, which makes it easier to manufacture the amorphous foil. When the concentration of C is less than 0.01%, the wettability between the molten metal and the cooling roll is not sufficiently improved. When the C concentration exceeds 4% however, improvement of wettability is saturated. In view of this, it is better to keep the C concentration in a range of 0.0°-4%, preferably the range is 0.5-3.5%.

The balance of the bonding alloy of this embodiment is Fe and residual impurities. Fe is one of the primary elements of the bonding alloy of this embodiment and if the concentration of Fe is less than 27%, the result may be insufficient strength of bonding of the Fe-based alloy base material. If the Fe concentration exceeds 65%, this may make it difficult to lower the melting point of the bonding alloy even if the concentration of the other elements remains within the range described above. In view of this, it is better to keep the Fe concentration in a range of 27-65%, preferably the range is 35-55%.

As described above, the bonding alloy of the first embodiment can be bonded to a Fe-based alloy base material and to a Ni-based alloy base material since the concentration of each of Fe and Ni of the bonding alloy, which is the base of Fe—Ni alloy, is optimized. That is, the liquid-phase diffusion bonding can be performed no matter whether a base material to be bonded is a Ni-based heat resistant material or Fe-based alloy steel, which greatly improves the workability/productivity of the bonding. Also, the optimized B concentration can lower the melting point of the bonding alloy. In other words, the heating temperature can be set lower than in the conventional way, which leads to prevention of the degradation of the structure, such as in the coarsening of crystal grains of the base material, and to realize an increase in the bonding strength.

A bonding alloy of the second embodiment of the present invention (this may be called simply “second invention”) is explained below. The bonding alloy of the second embodiment comprises, in atom percent (%), 22<Ni≦60, B: 7-18 and 4<C≦11, and the balance being Fe and residual impurities.

The inventors of the invention examined the melting point and the bonding performance of the bonding alloy in the range of a higher C concentration compared to the C concentration of the first embodiment while varying the concentration of each of B, Ni and Fe. As a result, in the case of increasing the C concentration, it was found that the melting point of the bonding alloy can be lowered by optimizing the concentration of B and the bonding strength can be increased in a similar fashion for the bonding alloy of the first embodiment. Specifically, when the concentration of C is 4<C≦11% and the concentration of B is 7-18%, the melting point can be lowered to 100° C. or less and sufficient strength of bonding can be obtained. With respect to each component to be added to the bonding alloy of this embodiment, the reason for the limited range of concentration is explained below. The reason for the addition of each component is the same as in the first embodiment.

With respect to B, the concentration range of B is 7-18%. When the concentration of B is less than 7% or exceeds 18%, while the concentration of C is more than 4%, sufficient lowering of melting point can not be made. Therefore, it is better to keep the concentration of B in a range of 7-18%, preferably the range is 9-11%.

With respect to C, the concentration range of C is 4<C≦11%. When the concentration of C exceeds 11%, a precipitation, such as carbide, is formed at the interface of bonding, which decreases the strength of the bonded portion. Therefore, it is better to keep the concentration of C in a range of 4<C≦11%, preferably the range is 7-9%.

The reason for the limited range of the concentration of Ni is the same as in the first embodiment. However, it is preferable to keep the concentration of Ni in the range of 27-53% in the bonding alloy of this embodiment since the strength of bonding can be further improved in the case of bonding to a Fe-based alloy material and the case of bonding to a Ni-based alloy material.

The balance of the bonding alloy of this embodiment is Fe and residual impurities. In the case where the concentration of B is 7-18% and the concentration of C is 4<C≦11%, when the concentration of Fe is set to less than 23%, the strength of the bonding of the Fe-based alloy material may become insufficient. When the concentration of Fe is more than 60%, it may be difficult to lower the melting point of the bonding alloy. In view of this, it is preferable to keep the concentration of Fe in a range of 23-60%, and more preferably 29-55%.

As described above, the bonding alloy of the second embodiment, as well as the bonding alloy of the first embodiment, can be applied to bond to the Fe-based alloy base material and to the Ni-based alloy base material since the concentration of each of Fe and Ni of the bonding alloy, is optimized. That is, the liquid-phase diffusion bonding can be performed no matter whether a base material to be bonded is a Ni-based heat resistance material or a Fe-based alloy steel, which greatly improves the workability/productivity of the bonding. Furthermore, in the case of the concentration of C of greater than that of the first embodiment, both lowering of melting point and improvement of the bonding strength can be realized, since both of the concentration of C and B is optimized.

The bonding alloys of the above first embodiment and the second embodiment can further include Si of which concentration range is 0.01≦Si<1.0% in addition to the components mentioned above. Although Si can be added to some extent in order to lower the melting point of the bonding alloy, Si forms an oxide which deteriorates the strength of bonding by combining with oxygen at the liquid-phase diffusion bonding when Si is included in a concentration of 0.01% or more. However, if the oxygen concentration of the atmosphere used for the bonding operation is kept much lower, e.g., less than 0.1% in volume, the formation of the oxide can be prevented, even if the concentration of Si is 0.01% or more. If the concentration of Si reaches or exceeds 1%, the formation of the oxide can not be prevented even if the inert atmosphere is applied, since a very slight amount of oxygen contained in the atmosphere can combine with Si to form the oxide. In view of above, in the case of adding Si, it is better for the liquid-phase diffusion bonding to be performed in an inert atmosphere and to keep the concentration of Si in the range 0.01≦Si<1.0%, which makes it possible to lower the melting point of the bonding alloy without lowering the strength of bonding.

The bonding alloys of the above first and second embodiments can further include W and/or Mo of which the total concentration range is 0.1-5% in addition to the components mentioned above. W and Mo have the capability of greatly lowering the melting point and the capability can be expressed when the concentration of each element of Fe, Ni, B, Si and C remains within the range of the present invention. In particular, W has the excellent capability of lowering the melting point of the bonding alloy so that the heating temperature for bonding can be lowered. However, this capability can not be expressed when the total concentration of W and/or Mo is less than 0.1% and the capability is saturated when the total concentration of W and/or Mo exceeds 5%. In view of this, it is better to keep the total content of W and/or Mo in 0.1-5%. This makes it possible to secure sufficient strength of bonding even if the bonding is performed in an oxidizing atmosphere.

The bonding alloys of the above first embodiment and the second embodiment can also include Cr: 0.1-20% in addition to components mentioned above. Cr is added mainly to increase the corrosion resistance and oxidation resistance when needed. However, if the concentration of Cr is less than 0.1%, the performance is insufficient and if the concentration of Cr exceeds 20%, the melting point of the bonding alloy is raised, which is undesired. In view of this, it is better to keep the concentration of Cr in the range of 0.1-20% when Cr addition is performed, preferably the range is 1-10%.

The bonding alloys of the above first and second embodiments can furthermore include V: 0.1-10% in addition to the components mentioned above. V has the capability of allowing bonding in an oxidizing atmosphere by converting an oxidized film formed on the surface of the base material into a complex oxide with a low melting point. The complex oxide, having a low melting point, can be melted at ordinary bonding temperatures and is formed into a roughly spherical shape in the melted bonding alloy because of the difference in the surface tension. Therefore, the melted complex oxide does not disturb diffusion of the other elements. For this reason, V addition makes it possible to perform more stable liquid-phase diffusion bonding even in an oxidizing atmosphere. However, if the concentration of V is less than 0.1%, the performance is insufficient and if the concentration of V exceeds 20%, the melting point of the bonding alloy is raised, which is undesired. In view of this, it is better to keep the concentration of V in the range of 0.1-10% when V addition is performed, preferably the range is 1-5%. Obviously, V addition works effectively whenever an oxidized film is formed on the bonding surface of the base material even in an inert atmosphere, although V addition is not limited to use in oxidizing atmosphere.

The melting point of the bonding alloy of the first and second embodiments of the present invention is explained below. In this invention, the bonding alloy having a melting point of 1030-1100° C. can be obtained by limiting the composition to the above-described parameters. However, if the melting point is below 1030° C., although it enables lowering of the bonding temperature, it also takes a longer time for an atom to diffuse, i.e., the bonding needs a longer time to be completed, which leads to low productivity. Also, if the bonding is performed under high temperatures using a bonding alloy having a melting point which is too low, there may be a problem that the bonding alloy would flow out before the temperature reaches the bonding temperature. Contrarily, if the melting point of the bonding alloy exceeds 1100° C., the higher temperature has to be applied to the bonding, which leads to a degradation of the structure (such as coarsening of crystal grains of the base material). In view of this, it is better to keep the melting point of the bonding alloy in the range of 1030-1100° C.

The strength of bonding of the base material to the bonding alloy of the first and the second embodiments, i.e., the strength of the bonded portion is 1.00 or more as a ratio of (tensile strength of bonded portion)/(tensile strength of base material).

The bonding alloy of the above first and the second embodiments are available in the form of a foil or powder. For example, the foil is easy to be handled when a bonding alloy is sandwiched between two base materials to be bonded. The thickness of the bonding alloy foil is preferably 3-200 μm, and more preferably 10-100 μm. If the surface of the base material to be bonded is bumpy, use of the powder form bonding alloy would be appropriate since the powder form bonding alloy can fill recesses of the bumpy surface. The average particle diameter of the bonding alloy powder is preferably 5-300 μm, and more preferably 10-200 μm. As for making a bonding alloy foil or powder, any known methods can be used. As for the foil form, for example, a single roll quenching method is preferable to make the foil form bonding alloy. In the single roll quenching method, a molten bonding alloy is ejected through a slot nozzle onto a rotating cooled substrate to be quenched to form a continuous strip of foil. In addition, a centrifugal quenching method using an inner wall of a dram or a method using an endless cooling belt are favorable. As for the powder form, for example, a gas atomized method is preferable or a method where an ingot is crushed and then ground using a ball mill is possible.

The effects of the present invention are explained below based on examples of this invention and comparison examples. In example 1 of the first invention, mother alloys each composition of which is shown in TABLE 1 below were cast using electrolytic Fe, electrolytic Ni, B and C each of which has purity of 99.9% in mass in an argon atmosphere. Each of the mother alloys was re-melted in a quartz crucible having a slot opening of 25 mm width and 0.4 mm gap and ejected through the slot onto a running surface of a copper cooling roll at the peripheral velocity of 25 m/sec. to be quenched to form an amorphous foil of 25 μm in thickness. Then, by heating and cooling the foil, the melting point was determined from an endothermic temperature or exothermic temperature at melting/solidifying. The results are also shown in TABLE 1.

TABLE 1

| | | Composition (atom %) | | | | |
|---|---|---|---|---|---|---|
| | | | | | Fe and | Melting |
| | | | | | residual | point |
| | No. | Ni | B | C | impuritieS | (° C.) |
| comparison | 1 | 12.0 | 14.5 | 2.0 | 71.5 | 1113 |
| sample | | | | | | |
| comparison | 2 | 15.0 | 14.5 | 2.0 | 68.5 | 1103 |
| sample | | | | | | |
| comparison | 3 | 18.0 | 14.5 | 2.0 | 65.5 | 1102 |
| sample | | | | | | |
| comparison | 4 | 20.5 | 13.5 | 2.0 | 64.0 | 1101 |
| sample | | | | | | |
| sample | 5 | 22.5 | 12.0 | 1.5 | 64.0 | 1092 |
| sample | 6 | 26.5 | 13.5 | 1.0 | 59.0 | 1082 |
| sample | 7 | 32.0 | 13.0 | 1.0 | 54.0 | 1076 |
| sample | 8 | 30.0 | 14.5 | 2.0 | 53.5 | 1070 |
| sample | 9 | 37.0 | 14.0 | 2.0 | 47.0 | 1061 |
| sample | 10 | 40.5 | 14.0 | 1.5 | 44.0 | 1055 |
| sample | 11 | 42.0 | 14.5 | 2.0 | 41.5 | 1044 |
| sample | 12 | 47.0 | 14.0 | 2.0 | 37.0 | 1042 |
| sample | 13 | 52.5 | 14.5 | 1.0 | 32.0 | 1041 |
| sample | 14 | 56.0 | 14.0 | 2.0 | 28.0 | 1038 |
| sample | 15 | 58.5 | 14.5 | 2.0 | 25.0 | 1039 |
| sample | 16 | 60.0 | 14.5 | 2.0 | 23.5 | 1040 |
| comparison | 17 | 70.0 | 14.5 | 2.0 | 13.5 | 1069 |
| sample | | | | | | |
| comparison | 18 | 29.0 | 11.0 | 1.8 | 58.2 | 1112 |
| sample | | | | | | |
| sample | 19 | 31.0 | 12.5 | 3.8 | 52.7 | 1080 |
| sample | 20 | 30.0 | 13.0 | 3.5 | 53.5 | 1065 |
| sample | 21 | 31.0 | 14.5 | 1.5 | 53.0 | 1068 |
| sample | 22 | 30.0 | 16.0 | 0.5 | 53.5 | 1072 |
| sample | 23 | 23.0 | 17.5 | 0.02 | 59.48 | 1093 |
| comparison | 24 | 23.5 | 19.5 | 1.0 | 56.0 | 1108 |
| sample | | | | | | |

Bonding experiments were performed using the bonding alloy foils for the examples and comparison examples prepared above and the strength of bonding was measured. More specifically, as the base material to be bonded, two kinds of rods, i.e., a rod with a 20 mm diameter made of STK 400 of Fe-based alloy material and a rod with a 20 mm diameter made of Inconel 600 of Ni-based heat resistance alloy were prepared respectively. A foil of a bonding alloy was doubled and sandwiched between two rods, then all of them were put in the heating furnace in a controlled atmosphere and the temperature was raised up to a temperature higher than the melting point by 50° C. or less and was maintained for 10 min and, then was cooled down. While the two rods were heated, they were pressed against each other with a pressure of 2 MPa to make a perfect contact. The heating furnace was kept in an Ar gas atmosphere. A test piece including a bonded portion was prepared for JIS Z2201 # 4 tensile test by cutting out from the bonded rods so that the test piece (or referred to as ‘sample’) held the bonded interface portion in the middle in the longitudinal direction. A notch (2 mm length, at a 45° angle) was formed on the test piece along the bonding line. The same shape of each test piece of the base material portion was cut out from each of the base material rods. The tensile test was carried out with respect to both the test piece including bonded portion and the test piece of base material to measure the strengths. TABLE 2 shows the results of the test where the ratio of (strength of bonded portion)/(strength of base material) is evaluated as a strength of bonding.

TABLE 2

strength of bonding
(strength of bonded portion)/
(strength of base material)

| | No. | STK400 | Inconel 600 |
|---|---|---|---|
| comparison | 1 | 0.82 | 0.79 |
| sample | | | |
| comparison | 2 | 0.85 | 0.80 |
| sample | | | |
| comparison | 3 | 0.95 | 0.89 |
| sample | | | |
| comparison | 4 | 1.00 | 0.95 |
| sample | | | |
| sample | 5 | 1.01 | 1.00 |
| sample | 6 | 1.01 | 1.01 |
| sample | 7 | 1.04 | 1.02 |
| sample | 8 | 1.04 | 1.02 |
| sample | 9 | 1.03 | 1.02 |
| sample | 10 | 1.03 | 1.03 |
| sample | 11 | 1.02 | 1.04 |
| sample | 12 | 1.02 | 1.04 |
| sample | 13 | 1.01 | 1.02 |
| sample | 14 | 1.00 | 1.01 |
| sample | 15 | 1.00 | 1.01 |
| sample | 16 | 1.00 | 1.01 |
| comparison | 17 | 0.98 | 1.00 |
| sample | | | |
| comparison | 18 | 0.92 | 0.96 |
| sample | | | |
| sample | 19 | 1.03 | 1.02 |
| sample | 20 | 1.03 | 1.02 |
| sample | 21 | 1.03 | 1.03 |
| sample | 22 | 1.02 | 1.03 |
| sample | 23 | 1.01 | 1.00 |
| comparison | 24 | 0.98 | 0.97 |
| sample | | | |

As for the bonding alloys of sample Nos. 1-24, there was no problem in making foils by ejecting the molten bonding alloy onto a running copper surface cooling roll, since the concentration of C of all the bonding alloy was 0.01% or more. Sample Nos. 5-16 and 19-23 show that the ratio of (strength of bonded portion)/(strength of base material) was 1.00 or more with respect to both Fe-based alloy material STK400 and Ni-based alloy material Inconel 600, i.e., the sample Nos. 5-16 and 19-23 were excellent in strength of bonding. All of the samples (test pieces) of Nos. 5-16 and 19-23, as shown in TABLE 2, had a B content of 12-18%, C content of 0.014%, Fe content of 27-65% and Ni content greater than 22% up to equal to 60% or less and the melting point was 1100° C. or less. Particularly in the samples of Nos. 7-12 where the Fe content was 35-55% and Ni content was 30-50%, the ratio of (strength of bonded portion)/(strength of base material) was 1.02 or more, i.e., the strength of bonding was greatly improved compared to comparison samples.

In comparison samples Nos. 1-4, where the concentration of Ni was less than that of the invention, the melting point of the bonding alloy was more than 1100° C. and the strength of bonding with respect to Ni-based alloy material Inconel 600 did not reach 1.00. A bonding alloy of comparison example No. 17 where the concentration of Ni was outside the range of the invention, had a low melting point and the strength of bonding with respect to Ni-based alloy material Inconel 600 was 1.00. However, the strength of bonding with respect to Fe-based alloy material STK 400 was lowered since Fe content was relatively lowered in No. 17.

In comparison sample No. 18, where the concentration of Fe and the concentration of Ni remained within the scope of the present invention, however, the concentration of B was less than that of the invention, and No. 24 where the concentration of B was beyond that of the invention, the melting point of the bonding alloy was high and the strength of bonding was less than 1.00. Particularly, the bonding alloy of No. 24 needed 20-30% longer time than that of other examples to complete the isothermal solidification.

### Example 2

Example 2 of the first embodiment of the invention is explained below. In this example 2, mother alloys each composition of which is shown in TABLE 3 below were cast using electrolytic Fe, electrolytic Ni, B, Si and C each of which had a purity of 99.9% in mass in an argon atmosphere. A foil of each of the mother alloys was prepared in the same way as in Example 1 above. Bonding experiments were performed in the same way as in Example 1 and the strength of bonding was measured. Fe-based alloy material STK 400 was used as a base material to be bonded. The results are shown in TABLE 3 below.

TABLE 3

| | | | | | | | | strength of bonding |
|---|---|---|---|---|---|---|---|---|
| | | composition (atom %) | | | | | | [STK400] |
| | | | | | | Fe and | melting | (strength of bonded |
| | | | | | | residual | point | portion)/(strength |
| | No. | Ni | B | Si | C | impurities | (° C.) | of base material) |
| sample | 31 | 26.5 | 13.49 | 0.01 | 1.0 | 59.0 | 1082 | 1.01 |
| sample | 32 | 26.5 | 13.43 | 0.07 | 1.0 | 59.0 | 1081 | 1.02 |
| sample | 33 | 26.5 | 13.39 | 0.11 | 1.0 | 59.0 | 1079 | 1.01 |
| sample | 34 | 26.5 | 13.26 | 0.24 | 1.0 | 59.0 | 1080 | 1.00 |
| sample | 35 | 26.5 | 13.02 | 0.48 | 1.0 | 59.0 | 1078 | 1.02 |
| sample | 36 | 26.1 | 13.59 | 0.71 | 1.0 | 58.6 | 1081 | 1.00 |
| sample | 37 | 26.1 | 13.39 | 0.94 | 1.0 | 58.57 | 1077 | 1.01 |
| comparison | 38 | 26.5 | 13.23 | 1.20 | 1.0 | 58.07 | 1076 | 0.98 |
| sample | | | | | | | | |

As shown in TABLE 3, bonding alloys of sample Nos. 31-37 where the concentration of Si remains within the scope of the present invention indicate that the ratio of (strength of bonded portion)/(strength of base material) was 1.00 or more, i.e., the sample Nos. 31-37 were excellent in strength of bonding. Contrarily, the strength of bonding was less than 1.00 in the bonding alloy of comparison sample No. 38 where the concentration of Si was outside the scope of the invention, although lowering of the melting point was realized. The test piece of sample No. 38 was embedded in the resin and grounded and etched to form a cross section viewing sample for observation. The cross section of the bonded surface of the comparison sample No. 38 was observed using an optical microscope and various oxides were found. Si and O were detected as primary components of the oxides using EPMA (Electron Probe X-ray Micro Analyzer), i.e., the oxide was found to be a Si oxide.

### Example 3

Example 3 of the first embodiment of the invention is explained below. In this Example 3, mother alloys each composition of which is shown in TABLE 4 below were cast using electrolytic Fe, electrolytic Ni, B, Si, C, W, Mo and Cr each of which has purity of 99.9% in mass in an argon atmosphere. A foil of each of the mother alloys were prepared in the same way as in Example 1 above. Bonding experiments were performed in the same way as in Example 1 and the strength of bonding was measured. Fe-based alloy material STK 400 was used as a base material to be bonded. The results are shown in TABLE 4 below.

TABLE 4

| | | | | | | | | | | | strength of bonding |
|---|---|---|---|---|---|---|---|---|---|---|---|
| | | composition (atom %) | | | | | | | | | [STK400] |
| | | | | | | | | | Fe and | melting | (strength of bonded |
| | | | | | | | | | residual | point | portion)/(strength |
| | No. | Ni | B | Si | C | W | Mo | Cr | impurities | (° C.) | of base material) |
| comparison | 41 | 12.00 | 14.50 | — | 2.02 | — | — | — | 71.48 | 1112 | 0.78 |
| sample | | | | | | | | | | | |
| comparison | 42 | 12.55 | 14.50 | — | 2.00 | — | 1.57 | — | 69.38 | 1110 | 0.81 |
| sample | | | | | | | | | | | |
| comparison | 43 | 12.35 | 14.50 | — | 2.05 | — | 4.75 | — | 66.35 | 1103 | 0.92 |
| sample | | | | | | | | | | | |
| sample | 44 | 30.00 | 14.50 | — | 2.04 | — | — | — | 53.46 | 1071 | 1.03 |
| sample | 45 | 30.28 | 14.48 | 0.27 | 2.01 | — | 0.07 | — | 52.89 | 1071 | 1.03 |
| sample | 46 | 30.18 | 14.54 | 0.67 | 2.03 | — | 0.12 | — | 52.46 | 1070 | 1.01 |
| sample | 47 | 30.11 | 14.55 | — | 2.02 | — | 0.52 | — | 52.80 | 1062 | 1.04 |
| sample | 48 | 30.33 | 14.66 | — | 2.03 | — | 1.56 | — | 51.41 | 1056 | 1.05 |
| sample | 49 | 30.56 | 14.77 | — | 2.05 | — | 2.62 | — | 50.00 | 1052 | 1.05 |
| sample | 50 | 30.42 | 14.50 | 0.35 | 2.01 | — | 3.58 | — | 49.49 | 1050 | 1.05 |
| sample | 51 | 30.21 | 14.65 | — | 2.00 | — | 4.87 | — | 48.27 | 1047 | 1.07 |
| comparison | 52 | 30.67 | 14.38 | — | 1.98 | — | 5.20 | — | 47.77 | 1047 | 1.07 |
| sample | | | | | | | | | | | |
| comparison | 53 | 12.48 | 14.50 | — | 2.00 | 1.41 | — | — | 69.61 | 1108 | 0.85 |
| sample | | | | | | | | | | | |
| comparison | 54 | 12.30 | 14.45 | — | 1.98 | 4.88 | — | — | 66.39 | 1102 | 0.96 |
| sample | | | | | | | | | | | |
| sample | 55 | 30.26 | 14.30 | 0.31 | 2.00 | 0.06 | — | — | 53.07 | 1070 | 1.01 |
| sample | 56 | 29.98 | 14.58 | 0.71 | 2.03 | 0.13 | — | — | 52.57 | 1068 | 1.00 |
| sample | 57 | 30.18 | 14.59 | — | 2.02 | 0.27 | — | — | 52.94 | 1052 | 1.04 |
| sample | 58 | 30.56 | 14.77 | — | 2.05 | 0.82 | — | — | 51.80 | 1040 | 1.06 |
| sample | 59 | 30.95 | 14.96 | — | 2.07 | 1.38 | — | — | 50.64 | 1050 | 1.06 |
| sample | 60 | 30.22 | 14.33 | — | 2.01 | 3.36 | — | — | 50.08 | 1047 | 1.08 |
| sample | 61 | 30.15 | 14.25 | — | 2.04 | 4.92 | — | — | 48.64 | 1043 | 1.09 |
| comparison | 62 | 30.68 | 14.30 | — | 2.00 | 5.18 | — | — | 47.84 | 1043 | 1.09 |
| sample | | | | | | | | | | | |
| sample | 63 | 30.33 | 14.33 | — | 2.01 | 0.12 | 0.18 | — | 53.03 | 1061 | 1.04 |
| sample | 64 | 30.89 | 14.29 | 0.16 | 2.02 | 0.42 | 0.46 | — | 51.76 | 1055 | 1.06 |
| sample | 65 | 30.74 | 14.56 | 0.58 | 1.98 | 1.62 | 1.58 | — | 48.94 | 1053 | 1.06 |
| sample | 66 | 30.28 | 14.84 | — | 2.08 | 2.44 | 2.38 | — | 47.98 | 1045 | 1.08 |
| comparison | 67 | 30.45 | 14.39 | — | 2.10 | 2.78 | 2.68 | — | 47.60 | 1045 | 1.08 |
| sample | | | | | | | | | | | |
| sample | 68 | 40.51 | 14.15 | — | 1.51 | — | — | 0.80 | 43.03 | 1057 | 1.02 |
| sample | 69 | 42.04 | 14.65 | 0.23 | 1.98 | — | — | 3.48 | 37.62 | 1055 | 1.02 |
| sample | 70 | 36.77 | 14.58 | — | 0.20 | — | 2.89 | 7.89 | 37.67 | 1071 | 1.00 |
| sample | 71 | 30.58 | 14.46 | — | 0.10 | 3.01 | — | 16.77 | 35.08 | 1087 | 1.01 |
| sample | 72 | 31.69 | 14.05 | — | 0.25 | 1.56 | 1.26 | 19.56 | 31.63 | 1098 | 1.00 |

As shown in TABLE 4 above, comparison samples Nos. 41-43, where the concentration of each of the primary elements Fe and Ni was outside of the scope of the present invention, the melting point was hardly lowered even when Mo was added within its concentration range of the invention and the ratio of (strength of bonded portion)/(strength of base material) was less than 1.00. Contrarily, sample Nos. 44-51, where the concentration of each of Fe, Ni, B, Si and C remain within the scope of the present invention, was found to be lowered in melting point by up to 65° C. when Mo was added within its content range of the invention and strength of bonding was improved. The melting point of comparison sample No. 52, where Mo was added at a concentration higher than range of the invention, i.e., 5%, was nearly equal to that of sample Nos. 44-51. In other words, the effect of Mo addition for lowering melting point was saturated when the concentration of Mo exceeded 5%.

Similar results were obtained with respect to element W. The comparison samples of Nos. 41, 53 and 54, where the concentration of each of the primary elements Fe and Ni was outside of the scope of the present invention, were hardly lowered in melting point even when W was added within the concentration range of the invention and the ratio of (strength of bonded portion)/(strength of base material) was less than 1.00. Contrarily, sample Nos. 55-61, where the concentration of each of Fe, Ni, B, Si and C remained within the scope of the present invention, showed a lowering in melting point by up to 69° C. when W was added within the concentration range of the invention and the strength of bonding was improved. The melting point of the comparison sample No. 62, where W was added at a concentration higher than the range of the invention, i.e., 5%, was nearly equal to that of sample Nos. 55-61. In other words, the effect of W addition for lowering melting point was saturated when the concentration of W exceeded 5%.

Sample Nos. 63-66, where the concentration of each of Fe, Ni, B, Si and C remained within the scope of the present invention and further Mo and W were added together within the concentration range of the invention, the melting point was lowered and the strength of bonding was improved. The melting point of comparison sample No. 67, where Mo and W were added together at concentration higher than the range of the invention, i.e., 5%, was nearly equal to that of sample Nos. 63-66. In other words, the effect of combined Mo and W addition for lowering the melting point was saturated when the concentration of Mo combined with W exceeds 5%.

Sample Nos. 68-72 where the concentration of Cr remained within the scope of the present invention was excellent in strength of bonding, i.e., the ratio of (strength of bonded portion)/(strength of base material) was 1.00 or more.

As for bonding alloy foils of sample Nos. 47-49, 57-59 and 63, the bonding test was carried out using the same foil samples after switching the atmosphere from Ar gas to air. The strength of each of samples was 1.00 for No. 47, 1.01 for No. 48, 1.00 for No. 49, 1.00 for No. 57, 1.01 for No. 58, 1.01 for No. 59 and 1.01 for No. 63. This showed sufficient strength of bonding was kept even when the bonding was performed in air.

### Example 4

Example 4 of the first invention is explained below. In this Example 4, mother alloys each composition of which is shown in TABLE 5 below were cast using electrolytic Fe, electrolytic Ni, B, Si, C, W, Mo, Cr and V each of which has a purity of 99.9% in mass in an argon atmosphere. A foil of each of the mother alloys was prepared in the same way as in Example 1 above. Bonding experiments were performed in the same way as in Example 1 except that the atmosphere was air and the strength of bonding was measured. Fe-based alloy material STK 400 was used as a base material to be bonded. The results are shown in TABLE 5 below.

TABLE 5

| | | | | | | | | | | | strength of bonding |
|---|---|---|---|---|---|---|---|---|---|---|---|
| | | composition (atom %) | | | | | | | | | [STK400] |
| | | | | | | | | | Fe and | melting | (strength of bonded |
| | | | | | | | | | residual | point | portion)/(strength |
| | No. | Ni | B | C | W | Mo | Cr | V | impurities | (° C.) | of base material) |
| comparison | 81 | 31.57 | 13.25 | 1.10 | — | — | — | 0.07 | 54.01 | 1079 | 0.68 |
| sample | | | | | | | | | | | |
| sample | 82 | 22.70 | 12.20 | 1.45 | — | — | — | 0.14 | 63.51 | 1094 | 1.00 |
| sample | 83 | 30.38 | 14.89 | 2.02 | — | 1.55 | 1.59 | 0.98 | 48.59 | 1061 | 1.02 |
| sample | 84 | 30.88 | 15.05 | 2.05 | 1.42 | — | — | 2.59 | 48.01 | 1053 | 1.03 |
| sample | 85 | 30.76 | 14.87 | 2.01 | 1.59 | 1.57 | — | 3.87 | 45.33 | 1058 | 1.04 |
| sample | 86 | 26.80 | 13.80 | 1.08 | — | — | — | 4.82 | 53.50 | 1088 | 1.02 |
| sample | 87 | 28.70 | 14.10 | 1.07 | — | — | 2.15 | 7.68 | 46.30 | 1096 | 1.01 |
| sample | 88 | 30.87 | 14.23 | 1.12 | — | — | — | 9.52 | 44.26 | 1095 | 1.00 |
| sample | 89 | 30.25 | 14.48 | 1.02 | 1.51 | 1.46 | 1.26 | 1.85 | 48.17 | 1068 | 1.02 |
| comparison | 90 | 31.05 | 14.32 | 1.08 | — | — | — | 10.98 | 42.57 | 1108 | 0.94 |
| sample | | | | | | | | | | | |

As shown in TABLE 5 above, comparison sample No. 81, where the concentration of V was less than 0.1% and the bonding was carried out in the air, was less than 1.00 in strength of bonding. In comparison sample No. 90, where the concentration of V was more than 10%, the melting point was raised and the strength of bonding was lowered. Contrarily in sample Nos. 82-89, the strength of bonding was excellent, i.e., 1.00 or more, even when the bonding was carried out in an oxidizing atmosphere.

### Example 5

Example 5 of the first invention is explained below. In this example, the same mother alloy as in sample Nos. 8 and 64 was used and the powdered bonding alloy of which particle diameter is 150 μm or less was prepared using gas-atomizing method. Circular opening diameter of the atomizing nozzle was 0.3 mm and Ar gas was used as an atomizing pressure gas. Ethanol was added to the prepared powdered bonding alloy to form a slurry. The slurry was applied onto the surface to be bonded of the base material so as to be about 100 μm in thickness. Then bonding experiments were performed in the same way as in Example 1 and the strength of bonding was measured.

The strength of bonding of the sample using the powdered bonding alloy of which mother alloy was 1.02 in the ratio of (strength of bonded portion)/(strength of base material) and was the same as that of sample No. 8, and the strength of bonding of the sample using the same mother alloy as that of sample No. 64 was 1.05, both showing excellent strength of bonding.

Example 6 of the second embodiment of the invention is explained below. In this example, mother alloys each composition of which is shown in TABLE 6 below were cast using electrolytic Fe, electrolytic Ni, B and C each of which has purity of 99.9% in mass in an argon atmosphere. Each of the mother alloys was re-melted in a quartz crucible having a slot opening of 25 mm width and 0.4 mm gap and ejected through the slot onto a running surface of copper cooling roll at the peripheral velocity of 25 m/sec. to be quenched to form an amorphous foil of 30 μm in thickness. Then, by heating and cooling the foil, the melting point was determined from the endothermic temperature or exothermic temperature at melting/solidifying. The result is also shown in TABLE 6.

TABLE 6

| | | composition (atom %) | | | | melting |
|---|---|---|---|---|---|---|
| | | | | | Fe and residual | point |
| | No. | Ni | B | C | impurities | (° C.) |
| comparison | 91 | 12.0 | 9.0 | 8.0 | 71.0 | 1110 |
| sample | | | | | | |
| comparison | 92 | 16.0 | 9.0 | 8.0 | 67.0 | 1106 |
| sample | | | | | | |
| comparison | 93 | 20.0 | 9.0 | 8.0 | 63.0 | 1101 |
| sample | | | | | | |
| sample | 94 | 23.0 | 9.0 | 8.0 | 60.0 | 1079 |
| sample | 95 | 27.5 | 9.0 | 9.0 | 54.5 | 1076 |
| sample | 96 | 31.0 | 10.0 | 8.0 | 51.0 | 1065 |
| sample | 97 | 34.0 | 10.0 | 7.0 | 49.0 | 1060 |
| sample | 98 | 37.5 | 9.0 | 8.0 | 45.5 | 1056 |
| sample | 99 | 41.5 | 10.0 | 7.0 | 41.5 | 1053 |
| sample | 100 | 43.0 | 10.0 | 8.0 | 39.0 | 1049 |
| sample | 101 | 48.0 | 9.0 | 8.0 | 35.0 | 1045 |
| sample | 102 | 53.0 | 9.0 | 9.0 | 29.0 | 1043 |
| sample | 103 | 58.0 | 9.0 | 9.0 | 24.0 | 1041 |
| sample | 104 | 60.0 | 9.0 | 8.0 | 23.0 | 1042 |
| comparison | 105 | 72.0 | 9.0 | 8.0 | 11.0 | 1075 |
| sample | | | | | | |
| sample | 106 | 36.0 | 8.0 | 5.0 | 51.0 | 1090 |
| sample | 107 | 35.0 | 8.0 | 10.0 | 47.0 | 1079 |
| sample | 108 | 36.0 | 11.0 | 5.0 | 48.0 | 1075 |
| sample | 109 | 36.0 | 11.0 | 7.0 | 46.0 | 1070 |
| sample | 110 | 35.0 | 11.0 | 10.0 | 44.0 | 1083 |
| sample | 111 | 35.0 | 17.0 | 5.0 | 43.0 | 1088 |
| sample | 112 | 36.0 | 17.0 | 10.0 | 37.0 | 1096 |
| comparison | 113 | 36.0 | 11.0 | 3.0 | 50.0 | 1156 |
| sample | | | | | | |
| comparison | 114 | 35.0 | 6.0 | 3.0 | 56.0 | 1194 |
| sample | | | | | | |
| comparison | 115 | 35.0 | 6.0 | 7.0 | 52.0 | 1188 |
| sample | | | | | | |
| comparison | 116 | 36.0 | 19.0 | 7.0 | 38.0 | 1172 |
| sample | | | | | | |
| comparison | 117 | 35.0 | 9.0 | 12.0 | 44.0 | 1095 |
| sample | | | | | | |
| comparison | 118 | 36.0 | 17.0 | 12.0 | 35.0 | 1085 |
| sample | | | | | | |

Bonding experiments were performed using the bonding alloy foil for examples and comparison examples prepared above and the strength of bonding was measured. Similar to that described above for Example 1, as base material to be bonded, two kinds of rods, i.e., a rod with a 20 mm diameter made of STK 400 of a Fe-based alloy material and a rod with a 20 mm diameter made of Inconel 600 of Ni-based heat resistance alloy were prepared. A foil of the bonding alloy was doubled and sandwiched between two rods, then all of them were put in the heating furnace capable of controlling atmosphere and kept for 10 min. after raising the temperature up to temperature higher than the melting point by 50° C. or less, and then the sample was cooled down. While the two rods were heated, they were pressed against each other by a pressure of 2 MPa to make a perfect contact. The heating furnace was kept in an Ar gas atmosphere. A test piece including a bonded portion for JIS Z2201 #4 tensile test was cut out from the bonded rods so that the test piece (sample) held the bonded interface portion in the middle in the longitudinal direction. A notch (2 mm length, angle 45°) was formed on the test piece along the bonding line. The same shape of the test piece of the base material portion was cut out from each of the base material rods.

TABLE 7

strength of bonding
(strength of bonded portion)/
(strength of base material)

| | No. | STK400 | Inconel 600 |
|---|---|---|---|
| comparison | 91 | 0.83 | 0.81 |
| sample | | | |
| comparison | 92 | 0.86 | 0.83 |
| sample | | | |
| comparison | 93 | 1.00 | 0.97 |
| sample | | | |
| sample | 94 | 1.02 | 1.01 |
| sample | 95 | 1.04 | 1.03 |
| sample | 96 | 1.03 | 1.02 |
| sample | 97 | 1.04 | 1.02 |
| sample | 98 | 1.04 | 1.03 |
| sample | 99 | 1.03 | 1.03 |
| sample | 100 | 1.02 | 1.04 |
| sample | 101 | 1.02 | 1.03 |
| sample | 102 | 1.02 | 1.02 |
| sample | 103 | 1.01 | 1.01 |
| sample | 104 | 1.00 | 1.01 |
| comparison | 105 | 0.97 | 1.00 |
| sample | | | |
| sample | 106 | 1.01 | 1.00 |
| sample | 107 | 1.02 | 1.01 |
| sample | 108 | 1.03 | 1.02 |
| sample | 109 | 1.04 | 1.03 |
| sample | 110 | 1.02 | 1.01 |
| sample | 111 | 1.00 | 1.00 |
| sample | 112 | 1.00 | 1.00 |
| comparison | 113 | 0.77 | 0.75 |
| sample | | | |
| comparison | 114 | 0.78 | 0.75 |
| sample | | | |
| comparison | 115 | 0.80 | 0.78 |
| sample | | | |
| comparison | 116 | 0.99 | 0.98 |
| sample | | | |
| comparison | 117 | 0.81 | 0.79 |
| sample | | | |
| comparison | 118 | 0.81 | 0.78 |
| sample | | | |

As for bonding alloys of sample Nos. 91-118, there was no problem in making foils by ejecting the molten bonding alloy onto a running copper surface cooling roll, since the C content of all the bonding alloy was 0.01% or more. Sample Nos. 94-104 and 106-112 show that the ratio of (strength of bonded portion)/(strength of base material) was 1.00 or more with respect to both Fe-based alloy material STK400 and Ni-based alloy material Inconel 600, i.e., the sample Nos. 5-16 and 19-23 were excellent in strength of bonding. All the samples (test pieces) of Nos. 94-104 and 106-112, as shown in TABLE 7, had the concentration of B of 7-18%, the concentration of C exceeding 4% up to 11%, the concentration of Fe of 23-60% and the concentration of Ni exceeding 22% up to 60% and the melting points were 1100° C. or less. Particularly in the samples of Nos. 95-102, 108 and 109 where the concentration of Fe was 29-55% and the concentration of Ni was 27-53%, the ratio of (strength of bonded portion)/(strength of base material) was 1.02 or more, i.e., the strength of bonding was greatly improved compared to comparison samples.

In comparison sample Nos. 91-93 where the concentration of Ni was less than the amount of the invention, the melting point of the bonding alloy was more than 1100° C. and the strength of bonding with respect to Ni-based alloy material Inconel 600 did not reach 1.00. A bonding alloy of comparison sample No. 105 where the concentration of Ni was higher than the range of the invention had a low melting point and strength of bonding with respect to Ni-based alloy material Inconel 600 was 1.00. However, the strength of bonding with respect to the Fe-based alloy material STK 400 was lowered, since the concentration of Fe was relatively lowered in No. 105.

In comparison sample Nos. 113-118, where the concentration of Fe and the concentration of Ni remain within the scope of the present invention, however, both the B content and the C content were outside of scope of the second embodiment of the invention, sufficient strength of bonding could not be obtained in any samples. As for the bonding alloy of sample Nos. 113-116, the melting point was high and the strength of bonding was less than 1.00. As for sample Nos. 117 and 118, although the compositions provided a low melting point, the strength of bonding was insufficient. The test piece of sample No. 117 or 118 was embedded in resin and grounded and etched to form a cross section viewing sample for observation. The cross section of bonded surface was observed using an optical microscope and precipitation was found. Components of the precipitation were detected using EPMA (Electron Probe X-ray Micro Analyzer), i.e., the carbide was found to be a component of the precipitation.

### Example 7

Example 7 of the second embodiment of the invention is explained below. In this Example 7, mother alloys of each composition of which is shown in TABLE 8 below were cast using electrolytic Fe, electrolytic Ni, B, Si and C each of which has a purity of 99.9% in mass in an argon atmosphere. A foil of each of the mother alloys was prepared in the same way as in Example 6 above. Bonding experiments were performed in the same way as in Example 6 and the strength of bonding was measured. Fe-based alloy material STK 400 was used as a base material to be bonded. The results are shown in TABLE 8 below.

TABLE 8

| | | | | | | | | strength of bonding |
|---|---|---|---|---|---|---|---|---|
| | | composition (atom %) | | | | | | [STK400] |
| | | | | | | Fe and | melting | (strength of bonded |
| | | | | | | residual | point | portion)/(strength |
| | No. | Ni | B | C | Si | impurities | (° C.) | of base material) |
| sample | 120 | 27.5 | 9.0 | 9.0 | 0.01 | 54.49 | 1075 | 1.02 |
| sample | 121 | 27.5 | 9.0 | 8.0 | 0.11 | 55.39 | 1074 | 1.01 |
| sample | 122 | 27.5 | 10.0 | 7.0 | 0.32 | 55.18 | 1077 | 1.01 |
| sample | 123 | 27.0 | 10.0 | 8.0 | 0.67 | 54.33 | 1078 | 1.00 |
| sample | 124 | 27.0 | 9.0 | 9.0 | 0.96 | 54.04 | 1074 | 1.01 |
| comparison | 125 | 27.0 | 9.0 | 9.0 | 1.18 | 53.82 | 1073 | 0.97 |
| sample | | | | | | | | |

As shown in TABLE, 8, bonding alloys of sample Nos. 120-124 where the concentration of Si remains within the scope of the present invention indicate that the ratio of (strength of bonded portion)/(strength of base material) was 1.00 or more, i.e., the sample Nos. 120-124 were excellent in strength of bonding. Contrarily, the strength of bonding was less than 1.00 in the bonding alloy of comparison sample No. 125, where the concentration of Si was higher than that of the invention, although lowering of the melting point was realized. The test piece of the sample No. 125 was embedded in the resin and grounded and etched to form a cross section viewing sample for observation. The cross section of bonded surface of the comparison sample No. 125 was observed using optical microscope and an oxide was found. Si and 0 were detected as primary components of the oxide using EPMA (Electron Probe X-ray Micro Analyzer), i.e., the oxide was found to be Si oxide.

### Example 8

Example 8 of the second embodiment of the invention is explained below. In this Example 8, mother alloys of each composition of which were shown in TABLE 9 below were cast using electrolytic Fe, electrolytic Ni, B, Si, C, W, Mo and Cr each of which has a purity of 99.9% in mass in an argon atmosphere. A foil of each of the mother alloys was prepared in the same way as in Example 6 above. Bonding experiments were performed in the same way as in Example 6 and the strength of bonding was measured. A Fe-based alloy material STK 400 was used as a base material to be bonded. The results are shown in TABLE 9 below.

TABLE 9

| | | | | | | | | | | | strength of bonding |
|---|---|---|---|---|---|---|---|---|---|---|---|
| | | Composition (atom %) | | | | | | | | | [STK400] |
| | | | | | | | | | Fe and | melting | (strength of bonded |
| | | | | | | | | | residual | point | portion)/(strength |
| | No. | Ni | B | C | Si | W | Mo | Cr | impurities | (° C.) | of base material) |
| comparison | 130 | 12.52 | 9.15 | 8.07 | — | — | — | — | 70.26 | 1110 | 0.86 |
| sample | | | | | | | | | | | |
| comparison | 131 | 12.55 | 9.08 | 8.01 | — | — | 1.80 | — | 68.56 | 1107 | 0.88 |
| sample | | | | | | | | | | | |
| comparison | 132 | 12.53 | 9.06 | 8.02 | — | — | 4.80 | — | 65.59 | 1102 | 0.97 |
| sample | | | | | | | | | | | |
| sample | 133 | 30.98 | 8.98 | 7.99 | — | — | — | — | 52.05 | 1066 | 1.03 |
| sample | 134 | 31.12 | 8.96 | 7.98 | 0.33 | — | 0.06 | — | 51.55 | 1065 | 1.03 |
| sample | 135 | 31.08 | 9.11 | 8.03 | 0.70 | — | 0.12 | — | 50.96 | 1065 | 1.04 |
| sample | 136 | 31.03 | 9.05 | 8.04 | — | — | 0.20 | — | 51.68 | 1063 | 1.04 |
| sample | 137 | 31.05 | 9.08 | 8.01 | — | — | 1.78 | — | 50.08 | 1057 | 1.05 |
| sample | 138 | 31.12 | 9.06 | 8.03 | — | — | 3.00 | — | 48.79 | 1051 | 1.05 |
| sample | 139 | 30.97 | 9.05 | 8.02 | 0.41 | — | 3.20 | — | 48.35 | 1050 | 1.05 |
| sample | 140 | 31.22 | 9.00 | 8.01 | — | — | 4.90 | — | 46.87 | 1044 | 1.06 |
| comparison | 141 | 31.22 | 9.13 | 8.03 | — | — | 5.18 | — | 46.44 | 1044 | 1.06 |
| sample | | | | | | | | | | | |
| comparison | 142 | 12.53 | 8.93 | 8.02 | — | 1.75 | — | — | 68.77 | 1108 | 0.88 |
| sample | | | | | | | | | | | |
| comparison | 143 | 12.54 | 8.89 | 8.06 | — | 4.77 | — | — | 65.74 | 1103 | 0.97 |
| sample | | | | | | | | | | | |
| sample | 144 | 31.18 | 8.88 | 7.89 | 0.31 | 0.07 | — | — | 51.67 | 1067 | 1.01 |
| sample | 145 | 31.05 | 9.02 | 8.11 | 0.72 | 0.12 | — | — | 50.98 | 1065 | 1.00 |
| sample | 146 | 31.03 | 9.03 | 8.03 | — | 0.18 | — | — | 51.73 | 1058 | 1.04 |
| sample | 147 | 30.98 | 9.05 | 7.96 | — | 1.82 | — | — | 50.19 | 1053 | 1.06 |
| sample | 148 | 30.96 | 9.07 | 7.86 | — | 3.22 | — | — | 48.89 | 1050 | 1.07 |
| sample | 149 | 31.11 | 9.11 | 7.99 | 0.41 | 3.12 | — | — | 48.26 | 1049 | 1.07 |
| sample | 150 | 31.06 | 9.01 | 8.02 | — | 4.89 | — | — | 47.02 | 1046 | 1.08 |
| comparison | 151 | 31.05 | 9.02 | 8.13 | — | 5.16 | — | — | 46.64 | 1046 | 1.08 |
| sample | | | | | | | | | | | |
| sample | 152 | 31.09 | 9.89 | 8.02 | — | 0.18 | 0.14 | — | 50.68 | 1060 | 1.03 |
| sample | 153 | 30.89 | 9.87 | 7.98 | 0.14 | 0.57 | 0.44 | — | 50.11 | 1054 | 1.05 |
| sample | 154 | 31.11 | 9.88 | 7.96 | 0.67 | 1.63 | 1.44 | — | 47.31 | 1046 | 1.07 |
| sample | 155 | 31.12 | 9.13 | 7.96 | — | 2.47 | 2.35 | — | 46.97 | 1042 | 1.08 |
| comparison | 156 | 31.03 | 9.06 | 8.03 | — | 2.65 | 2.73 | — | 46.50 | 1042 | 1.08 |
| sample | | | | | | | | | | | |
| sample | 157 | 40.32 | 9.07 | 8.05 | — | — | — | 0.90 | 41.66 | 1055 | 1.02 |
| sample | 158 | 43.01 | 9.07 | 8.06 | 0.16 | — | — | 3.63 | 36.07 | 1056 | 1.02 |
| sample | 159 | 37.48 | 9.08 | 8.07 | — | 2.98 | — | 18.70 | 23.69 | 1086 | 1.00 |
| sample | 160 | 30.56 | 9.02 | 7.98 | — | — | 3.12 | 17.80 | 31.52 | 1073 | 1.01 |
| sample | 161 | 31.49 | 9.89 | 7.96 | — | 1.45 | 1.32 | 19.55 | 28.34 | 1099 | 1.00 |

As shown in TABLE 9 above, comparison samples Nos. 130-132, where the concentration of each of the primary elements Fe and Ni was outside of the scope of the present invention, the melting point was hardly lowered even though Mo was added within its concentration range of the invention and the ratio of (strength of bonded portion)/(strength of base material) was less than 1.00. Contrarily, sample Nos. 133-140, where the concentration of each of Fe, Ni, B, Si and C remained within the scope of the second embodiment of the invention, the melting point was lowered by up to 65° C. when Mo was added within its concentration range of the invention and the strength of bonding was improved. The melting point of comparison sample No. 141, where Mo was added in a concentration higher than the range of the invention, i.e., 5%, was nearly equal to that of sample Nos. 133-140. In other words, the effect of Mo addition for lowering the melting point was saturated when the concentration of Mo exceeded 5%.

Similar results were obtained with respect to element W. Comparison sample Nos. 142 and 143, where the concentration of each of the primary elements Fe and Ni was outside of the scope of the present invention, were hardly lowered in melting point even though W was added within its content range of the invention and the ratio of (strength of bonded portion)/(strength of base material) was less than 1.00. Contrarily, sample Nos. 144-150, where the concentration of each of Fe, Ni, B, Si and C remained within the scope of the second embodiment of the invention, the melting point could be lowered by up to 65° C. when W is added within its concentration range of the invention and the strength of bonding was improved. The melting point of the comparison sample No. 151, where W was added at a concentration higher than the range of the invention, i.e., 5%, was nearly equal to that of sample Nos. 144-150. In other words, the effect of W addition for lowering melting point was saturated when the concentration of W exceeded 5%.

Sample Nos. 152-155, where the concentration of each of Fe, Ni, B, Si and C remained within the scope of the second embodiment of the invention and further Mo and W were added together within the concentration range of the invention, the melting point was lowered and strength of bonding was improved. The melting point of comparison sample No. 156, where Mo and W were added together at a concentration higher than the range of the invention, i.e., 5%, was nearly equal to that of sample Nos. 152-155. In other words, the effect of combined Mo and W addition for lowering the melting point was saturated when the combined Mo and W total concentration exceeds 5%.

Sample Nos. 157-161, where the concentration of Cr remained within the scope of the present invention, had excellent strength of bonding, i.e., the ratio of (strength of bonded portion)/(strength of base material) was 1.00 or more.

As for bonding alloy foils of sample Nos. 133, 136-138, 146-148, 152 and 155, the bonding test was carried out using the same foil samples after switching the atmosphere from Ar gas to air. The strength of each of the samples was 1.01 for No. 133, 1.02 for No. 136, 1.01 for No. 137, 1.02 for No. 138, 1.00 for No. 146, 1.01 for No. 147, 1.02 for No. 148, 1.01 for No. 152 and 1.02 for No. 155. This shows that sufficient strength of bonding was kept even when the bonding was performed in air.

### Example 9

Example 9 of the second embodiment of the invention is explained below. In this Example 9, mother alloys each composition of which is shown in TABLE 10 below were cast using electrolytic Fe, electrolytic Ni, B, Si, C, W, Mo, Cr and V each of which had a purity of 99.9% in mass in an argon atmosphere. A foil of each of the mother alloys was prepared in the same way as in Example 6 above. Bonding experiments were performed in the same way as in Example 6 except that the atmosphere was in air. The strength of bonding was measured. A Fe-based alloy material STK 400 was used as a base material to be bonded. The results are shown in TABLE 10 below.

TABLE 10

| | | | | | | | | | | | strength of bonding |
|---|---|---|---|---|---|---|---|---|---|---|---|
| | | composition (atom %) | | | | | | | | | [STK400] |
| | | | | | | | | | Fe and | melting | (strength of bonded |
| | | | | | | | | | residual | point | portion)/(strength |
| | No. | Ni | B | C | W | Mo | Cr | V | impurities | (° C.) | of base material) |
| comparison | 170 | 30.98 | 9.25 | 8.02 | — | — | — | 0.08 | 51.75 | 1075 | 0.71 |
| sample | | | | | | | | | | | |
| sample | 171 | 22.50 | 8.65 | 8.56 | — | — | — | 0.13 | 60.29 | 1096 | 1.00 |
| sample | 172 | 31.11 | 10.02 | 7.23 | — | 1.88 | — | 2.12 | 49.76 | 1053 | 1.03 |
| sample | 173 | 31.02 | 9.25 | 6.89 | — | 2.03 | 1.72 | 1.02 | 49.09 | 1056 | 1.04 |
| sample | 174 | 30.89 | 10.56 | 7.56 | 1.98 | — | — | 2.43 | 49.01 | 1051 | 1.04 |
| sample | 175 | 31.02 | 8.78 | 8.98 | 2.01 | — | 1.63 | 0.98 | 47.58 | 1053 | 1.03 |
| sample | 176 | 31.14 | 9.88 | 9.32 | 1.63 | 1.67 | — | 3.64 | 46.36 | 1056 | 1.03 |
| sample | 177 | 27.23 | 10.11 | 7.56 | — | — | — | 4.93 | 55.10 | 1089 | 1.02 |
| sample | 178 | 29.03 | 9.25 | 8.65 | — | — | 2.35 | 7.43 | 50.72 | 1093 | 1.01 |
| sample | 179 | 31.02 | 9.56 | 6.89 | — | — | — | 9.63 | 52.53 | 1097 | 1.00 |
| sample | 180 | 31.04 | 9.45 | 7.88 | 1.56 | 1.43 | 1.36 | 1.56 | 47.28 | 1062 | 1.03 |
| comparison | 181 | 31.03 | 10.24 | 7.25 | — | — | — | 10.86 | 51.48 | 1107 | 0.97 |
| sample | | | | | | | | | | | |

As shown in TABLE 10 above, comparison sample No. 170, where the concentration of V was less than 0.1% and the bonding was carried out in air, was less than 1.00 in strength of bonding. In comparison sample No. 181, where the concentration of V was more than 10%, the melting point was raised and the strength of bonding was lowered. Contrarily, in sample Nos. 171-180 where the concentration of V remained within the scope of the present invention, the strength of bonding was excellent, i.e., 1.00 or more, even when the bonding was carried out in an oxidizing atmosphere.

### Example 10

Example 10 of the second embodiment of the invention is explained below. In this example, the same mother alloy as in samples Nos. 96 and 153 was used and the powdered bonding alloy having a particle diameter of 150 μm or less was prepared using the gas-atomizing method. The circular opening diameter of the atomizing nozzle was 0.3 mm and Ar gas was used as an atomizing pressure gas. Ethanol was added to the prepared powdered bonding alloy to form a slurry. The slurry was applied onto surface to be bonded of base material so as to be about 100 μm in thickness. Then, bonding experiments were performed in the same way as in Example 6 and the strength of bonding was measured.

The strength of bonding of the sample using the powdered bonding alloy of which mother alloy is the same as that of sample No. 96 was 1.02 in the ratio of (strength of bonded portion)/(strength of base material), and the strength of bonding of sample using the same mother alloy as that of sample No. 153 was 1.04, i.e., both had excellent strength of bonding.

All references cited hereinabove are incorporated by reference in their entirety.

1-20. (canceled)

21. An alloy for liquid-phase diffusion bonding, consisting of in atom percent (%):
Ni: 30-50, Fe: 35-55,
B: 12-18,
C: 0.01-4, and optionally one or more selected
0.01≦Si<1,
W: 0.7-5,
Mo: 0.1-5
Cr: 0.1-20, and
V: 0.1-10,
and residual impurities, wherein the total amount of the elements is 700 atom percent (%).

22. An alloy for liquid-phase diffusion bonding, comprising in atom percent (%):
22<Ni≦60,
B: 7-18,
4<C≦11, optionally one or more selected from
0.01≦Si<1,
W: 0.7-5,
Mo: 0.1-5,
Cr: 0.1-20 and
V: 0.1-10
and the balance being Fe and residual impurities.

23. The alloy as in claim 21 or 22, wherein the alloy has a melting point of 1030-1100° C. and has a ratio of (tensile strength of bonded portion)/(tensile strength of base material) of 1.00 or more.

24. The alloy as in claim 21 or 22, wherein the alloy is in the form of a powder having an average particle diameter of 5-300 μm.

25. The alloy as in claim 21 or 22, wherein the alloy is in the form of a foil having a thickness of 3-200 μm.

26. A structure comprising at least two components comprising a nickel based alloy base material bonded to each other through the alloy as claimed in claim 21 or 22.

27. A structure comprising at least two components comprising an iron based steel material bonded to each other through the alloy as claimed in claim 21 or 22.
